(19) United States
(12) Patent Application Publication
(10) Pub. No.: US 2018/0254516 A1
(43) Pub. Date: Sep. 6, 2018

(54) NON-AQUEOUS ELECTROLYTES FOR HIGH ENERGY LITHIUM-ION BATTERIES

(71) Applicant: Sion Power Corporation, Tucson, AZ (US)

(72) Inventors: Zhenji Han, Osaka (JP); Martin Schulz-Dobrick, Fukushima (JP)

(73) Assignee: Sion Power Corporation, Tucson, AZ (US)

(21) Appl. No.: 15/765,362

(22) PCT Filed: Sep. 27, 2016
(86) PCT No.: PCT/EP2016/072997

§ 371 Date: Apr. 2, 2018

(30) Foreign Application Priority Data
Oct. 2, 2015 (EP) 15188192.5

(51) Int. Cl. H01M 10/0525; H01M 10/0567; H01M 10/0569; H01M 4/38; H01M 4/505; H01M 4/525; H01M 4/58; H01M 4/583

(52) U.S. Cl. CPC H01M 10/0525; H01M 10/0567; H01M 10/0569; H01M 4/386; H01M 2004/027; H01M 4/525; H01M 4/5825; H01M 4/583; H01M 2300/0028; H01M 4/505

(57) ABSTRACT

An electrochemical cell comprising (E) an anode comprising at least one anode active material; (F) a cathode comprising at least one cathode active material selected from lithium intercalating transition metal oxides with layered structure having the general formula (I) Li_{(1+y)}[NiₐCo_{b}Mn_{c}]_{(1-y)}O₂₊ₑ wherein y is 0 to 0.3, a, b and c may be same or different and are independently 0 to 0.8, a+b+c=1, −0.1≤e≤0, and wherein the molar ratio of Ni:(CO+Mn), and lithium intercalating mixed oxides of Ni, CO and Al and optionally Mn; and (C) an electrolyte composition containing (i) at least one aprotic organic solvent; (ii) at least one lithium conducting salt; (iii) at least one compound selected from lithium bis(oxalato) borate, lithium difluorooxalato borate, and cyclic carbonates containing at least one double bond; (iv) at least one compound selected from LiPO₂F₂, (CH₃CH₂O)₂P(O)F, LiN(SO₂CF₃)₂, LiN(SO₂F)₂, and LiBF₄; and (v) optionally one or more further additives; wherein the electrolyte composition (C) contains essentially no halogenated organic carbonate.

The present invention relates to an electrochemical cell comprising
(A) an anode comprising at least one anode active material;
(B) a cathode comprising at least one cathode active material different from LiCoO₂ and selected from lithium intercalating transition metal oxides with layered structure, lithium intercalating manganese-containing spinels, and lithiated transition metal phosphates; and
(C) an electrolyte composition containing
   (i) at least one aprotic organic solvent;
   (ii) at least one lithium conducting salt;
   (iii) at least one compound selected from lithium bis(oxalato) borate, lithium difluorooxalato borate, and cyclic carbonates containing at least one double bond;
   (iv) at least one compound selected from LiPO₂F₂, (CH₃CH₂O)₂P(O)F, LiN(SO₂CF₃)₂, LiN(SO₂F)₂, and LiBF₄; and
   (v) optionally one or more further additives;

wherein the electrolyte composition (C) contains essentially no halogenated organic carbonate.

Storing electrical energy is a subject of still growing interest. Efficient storage of electric energy allows electric energy to be generated when it is advantageous and to be used when needed. Secondary electrochemical cells are well suited for this purpose due to their reversible conversion of chemical energy into electrical energy and vice versa (rechargeability). Secondary lithium batteries are of special interest for energy storage since they provide high energy density and specific energy due to the small atomic weight of the lithium ion, and the high cell voltages that can be obtained (typically 3 to more than 4 V) in comparison with other battery systems. For that reason, these systems have become widely used as a power source for many portable electronics such as cellular phones, laptop computers, mini-cameras, etc.

In secondary lithium batteries like lithium ion batteries organic carbonates, ethers, esters and ionic liquids are used as sufficiently polar solvents for solvating the conducting salt(s). Most state of the art lithium ion batteries in general comprise not a single solvent but a solvent mixture of different organic aprotic solvents.

Besides solvent(s) and conducting salt(s) an electrolyte composition usually contains further additives to improve certain properties of the electrolyte composition and of the electrochemical cell comprising said electrolyte composition. Common additives are for example flame retardants, overcharge protection additives and film forming additives which react during first charge/discharge cycle on the electrode surface thereby forming a film on the electrode. The film protects the electrode from direct contact with the electrolyte composition. One well-known additive is monfluoroethylene carbonate (FEC) which may also be used as solvent. FEC has been widely used in lithium ion batteries. It is especially known to improve the performance of electrochemical cells comprising silicon containing electrodes. Silicon based materials suffer from huge volume changes and high reactivity with electrolyte which make it difficult in practical application.

EP 2144321 A1 discloses inter alia electrolyte compositions containing a conducting salt and non-aqueous solvents, and a monofluorophosphate and/or difluorophosphate wherein the non-aqueous solvents comprises a carbonate having a halogen atom, e.g. FEC.

However, FEC is consumed at the silicon based electrode during cycling and a certain amount of FEC is needed to keep capacity during cycling. Unfortunately, large amounts of FEC are easily consumed at high temperature which causes capacity fading and the development of gas within the electrochemical cell.

It is an objective of the present invention to provide electrochemical cells comprising an alternative electrolyte composition which can be used with silicon containing anodes which shows less gassing than the FEC containing electrolyte composition. At the same time the electrochemical cell comprising said electrolyte composition should show high electrochemical performance over a wide temperature range, in particular cycle stability, energy density, power capability and a long shelf life.

Accordingly, the electrochemical cell defined at the outset is provided. The inventive electrochemical cell shows good capacity retention and only low gassing during cycling.

The electrochemical cell according to the invention comprises an electrolyte composition (C), also referred to as component (C). Viewed chemically, an electrolyte composition is any composition which comprises free ions and as a result is electrically conductive. The most typical electrolyte composition is an ionic solution, although molten electrolyte compositions and solid electrolyte compositions are likewise possible.

Electrolyte composition (C) contains
(i) at least one aprotic organic solvent;
(ii) at least one lithium conducting salt;
(iii) at least one compound selected from lithium bis(oxalato) borate, lithium difluorooxalato borate, and cyclic carbonates containing at least one double bond;
(iv) at least one compound selected from LiPO₂F₂, (CH₃CH₂O)₂P(O)F, LiN(SO₂CF₃)₂, LiN(SO₂F)₂, and LiBF₄; and
(v) optionally one or more further additives;
   wherein the electrolyte composition (C) contains essentially no halogenated organic carbonate.

In the context of the present invention, the expression “essentially contains no halogenated organic carbonate” means in particular that the respective electrolyte composition contains less than 1 wt.-% of halogenated organic carbonate(s), said percentage referring to the total weight of the electrolyte composition (C). Preferably electrolyte composition (C) contains less than 0.5 wt.-%, more preferred less than 0.1 wt.-%, even more preferred 0.01 wt.-% and most preferred less than 0.001 wt.-% halogenated organic carbonate(s), based on the total weight of the electrolyte composition.

The term “halogenated carbonate(s)” means any cyclic or acyclic organic carbonate as described below which is substituted by one or more halogen atoms, i.e. substituted by one or more substituents selected from F, Cl, Br and I. Halogenated carbonate(s) include fluorinated cyclic carbonates like monofluoroethylene carbonate (FEC), 4-fluoro-5-methyl ethylene carbonate, 4-(fluoromethyl) ethylene carbonate, 4-(trifluoromethyl) ethylene carbonate, and 4,5-difluoroethylene carbonate and fluorinated acyclic carbonates like fluoromethyl methyl carbonate, bis(monofluoromethyl) carbonate, ethyl-(2,2,2-trifluoroethyl) carbonate, ethyl-(2,2-difluoroethyl) carbonate, and bis(2,2,2-trifluoroethyl) carbonate.

The electrolyte composition (C) preferably contains at least one aprotic organic solvent (i), more preferred at least two aprotic organic solvents (i). According to one embodiment the electrolyte composition may contain up to ten aprotic organic solvents (i). The one or more aprotic solvents present in electrolyte composition (C) are also referred to as component or solvent (i).

Solvent (i) is preferably selected from cyclic and acyclic organic carbonates, di-C₁-C₁₀-alkylethers, di-C₁-C₄-alkyl-C₂-C₆-alkylene ethers and polyethers, cyclic ethers, cyclic and acyclic acetals and ketals, orthocarboxylic acids esters, cyclic and acyclic esters of carboxylic acids, cyclic and acyclic sulfones, and cyclic and acyclic nitriles and dinitriles. More preferred solvent (i) is selected from cyclic and acyclic organic carbonates, and most preferred, electrolyte composition (C) contains at least two solvents (i) selected from cyclic and acyclic organic carbonates, electrolyte composition (C) contains at least one solvent (i) selected from cyclic organic carbonates and at least one solvent (i) selected from acyclic organic carbonates.

Examples of cyclic organic carbonates are ethylene carbonate (EC), propylene carbonate (PC) and butylene carbonate (BC), wherein one or more H of the alkylene chain may be substituted by an C₁ to C₄ alkyl group, e.g. 4-methyl ethylene carbonate and cis- and trans-dimethylethylene carbonate. Preferred cyclic organic carbonates are ethylene carbonate and propylene carbonate, in particular ethylene carbonate

Examples of acyclic organic carbonates are di-C₁-C₁₀-alkylcarbonates wherein each alkyl group may be selected independently from each other, preferred are di-C₁-C₄-alkylcarbonates. Examples are e.g. diethyl carbonate (DEC), ethyl methyl carbonate (EMC), dimethyl carbonate (DMC), methylpropyl carbonate, di-n-propyl carbonate and diisopropylcarbonate. Preferred acyclic organic carbonates are diethyl carbonate (DEC), ethyl methyl carbonate (EMC), and dimethyl carbonate (DMC).

In one embodiment of the invention electrolyte composition (C) contains mixtures of acyclic organic carbonates and cyclic organic carbonates at a ratio by weight of from 1:10 to 10:1, preferred of from 3:1 to 1:1.

According to the invention each alkyl group of di-C₁-C₁₀-alkylethers may be selected independently from the other. Examples of di-C₁-C₁₀-alkylethers are dimethylether, ethylmethylether, diethylether, methylpropylether, diisopropylether, and di-n-butylether.

Examples of di-C₁-C₄-alkyl-C₂-C₆-alkylene ethers are 1,2-dimethoxyethane, 1,2-diethoxyethane, diglyme (diethylene glycol dimethyl ether), triglyme (triethyleneglycol dimethyl ether), tetraglyme (tetraethyleneglycol dimethyl ether), and diethylenglycoldiethylether.

Examples of suitable polyethers are polyalkylene glycols, preferably poly-C₁-C₄-alkylene glycols and especially polyethylene glycols. Polyethylene glycols may comprise up to 20 mol % of one or more C₁-C₄-alkylene glycols in copolymerized form. Polyalkylene glycols are preferably dimethyl- or diethyl-end-capped polyalkylene glycols. The molecular weight M_{w} of suitable polyalkylene glycols and especially of suitable polyethylene glycols may be at least 400 g/mol. The molecular weight M_{w} of suitable polyalkylene glycols and especially of suitable polyethylene glycols may be up to 5 000 000 g/mol, preferably up to 2 000 000 g/mol.

Examples of cyclic ethers are 1,4-dioxane, tetrahydrofuran, and their derivatives like 2-methyl tetrahydrofuran.

Examples of acyclic acetals are 1,1-dimethoxymethane and 1,1-diethoxymethane. Examples of cyclic acetals are 1,3-dioxane, 1,3-dioxolane, and their derivatives such as methyl dioxolane.

Examples of acyclic orthocarboxylic acid esters are tri-C₁-C₄ alkoxy methane, in particular trimethoxymethane and triethoxymethane. Examples of suitable cyclic orthocarboxylic acid esters are 1,4-dimethyl-3,5,8-trioxabicyclo[2.2.2]octane and 4-ethyl-1-methyl-3,5,8-trioxabicyclo[2.2.2]octane.

Examples of acyclic esters of carboxylic acids are ethyl and methyl formiate, ethyl and methyl acetate, ethyl and methyl proprionate, and ethyl and methyl butanoate, and esters of dicarboxylic acids like 1,3-dimethyl propanedioate. An example of a cyclic ester of carboxylic acids (lactones) is γ-butyrolactone.

Examples of cyclic and acyclic sulfones are ethyl methyl sulfone, dimethyl sulfone, and tetrahydrothiophene-S,S-dioxide (sulfolane).

Examples of cyclic and acyclic nitriles and dinitriles are adipodinitrile, acetonitrile, propionitrile, and butyronitrile.

The electrolyte composition (C) contains at least one lithium conducting salt (ii), hereinafter also being referred to as conducting salt (ii) or component (ii). The electrolyte composition functions as a medium that transfers ions participating in the electrochemical reaction taking place in an electrochemical cell. The conducting salt(s) (ii) present in the electrolyte are usually solvated in the aprotic organic solvent(s) (i). The lithium conducting salt (ii) is preferably selected from the group consisting of
Li[F₆₋ₓP(C_{y}F_{2y+1})ₓ], wherein x is an integer in the range from 0 to 6 and y is an integer in the range from 1 to 20;
Li[B(R^{I})₄], Li[B(R^{I})₂(OR^{II}O)] and Li[B(OR^{II}O)₂] wherein each R^{I} is independently from each other selected from F, Cl, Br, I, C₁-C₄ alkyl, C₂-C₄ alkenyl, C₂-C₄ alkynyl, OC₁-C₄ alkyl, OC₂-C₄ alkenyl, and OC₂-C₄ alkynyl wherein alkyl, alkenyl, and alkynyl may be substituted by one or more OR^{III}, wherein R^{III} is selected from C₁-C₆ alkyl, C₂-C₆ alkenyl, and C₂-C₆ alkynyl, and
(OR^{II}O) is a bivalent group derived from a 1,2- or 1,3-diol, a 1,2- or 1,3-dicarboxlic acid or a 1,2- or 1,3-hydroxycarboxylic acid, wherein the bivalent group forms a 5- or 6-membered cycle via the both oxygen atoms with the central B-atom;
LiClO₄; LiAsF₆; LiCF₃SO₃; Li₂SiF₆; LiSbF₆; LiAlCl₄, Li(N(SO₂F)₂), lithium tetrafluoro (oxalato) phosphate; lithium oxalate; and
salts of the general formula Li[Z(CₙF₂ₙ₊₁SO₂)ₘ], where m and n are defined as follows:
m=1 when Z is selected from oxygen and sulfur,
m=2 when Z is selected from nitrogen and phosphorus,
m=3 when Z is selected from carbon and silicon, and
n is an integer in the range from 1 to 20.

Suited 1,2- and 1,3-diols from which the bivalent group (OR^{II}O) is derived may be aliphatic or aromatic and may be selected, e.g., from 1,2-dihydroxybenzene, propane-1,2-diol, butane-1,2-diol, propane-1,3-diol, butan-1,3-diol, cyclohexyl-trans-1,2-diol and naphthalene-2,3-diol which are optionally are substituted by one or more F and/or by at least one straight or branched non fluorinated, partly fluorinated or fully fluorinated C₁-C₄ alkyl group. An example for such 1,2- or 1,3-diole is 1,1,2,2-tetra(trifluoromethyl)-1,2-ethane diol.

“Fully fluorinated C₁-C₄ alkyl group” means, that all H-atoms of the alkyl group are substituted by F.

Suited 1,2- or 1,3-dicarboxlic acids from which the bivalent group (OR^{II}O) is derived may be aliphatic or aromatic, for example oxalic acid, malonic acid (propane-1,3-dicarboxylic acid), phthalic acid or isophthalic acid, preferred is oxalic acid. The 1,2- or 1,3-dicarboxlic acid are optionally substituted by one or more F and/or by at least one straight or branched non fluorinated, partly fluorinated or fully fluorinated C₁-C₄ alkyl group.

Suited 1,2- or 1,3-hydroxycarboxylic acids from which the bivalent group (OR^{II}O) is derived may be aliphatic or aromatic, for example salicylic acid, tetrahydro salicylic acid, malic acid, and 2-hydroxy acetic acid, which are optionally substituted by one or more F and/or by at least one straight or branched non fluorinated, partly fluorinated or fully fluorinated C₁-C₄ alkyl group. An example for such 1,2- or 1,3-hydroxycarboxylic acids is 2,2-bis(trifluoromethyl)-2-hydroxy-acetic acid.

Examples of Li[B(R^{I})₄], Li[B(R^{I})₂(OR^{II}O)] and Li[B(OR^{II}O)₂] are LiBF₄, lithium difluoro oxalato borate and lithium dioxalato borate.

Preferably the at least one conducting salt (ii) is selected from LiPF₆, LiAsF₆, LiSbF₆, LiCF₃SO₃, LiBF₄, lithium bis(oxalato) borate, LiClO₄, LiN(SO₂C₂F₅)₂, LiN(SO₂CF₃)₂, LiN(SO₂F)₂, and LiPF₃(CF₂CF₃)₃, more preferred the conducting salt (ii) is selected from LiPF₆ and LiBF₄, and the most preferred conducting salt is LiPF₆.

The at least one lithium conducting salt (ii) is usually present at a minimum concentration of at least 0.1 m/l, preferably the concentration of the at least one conducting salt (ii) is 0.5 to 2 mol/I based on the entire electrolyte composition.

Furthermore, electrolyte composition (C) contains at least one compound (iii) selected from lithium bis(oxalato) borate, lithium difluorooxalato borate, and cyclic carbonates containing at least one double bond, hereinafter also referred to as component (iii). The cyclic carbonates containing at least one double bond include cyclic carbonates wherein a double bond is part of the cycle like vinylene carbonate, methyl vinylene carbonate, and 4,5-dimethyl vinylene carbonate; and cyclic carbonate wherein the double bond is not part of the cycle, e.g. methylene ethylene carbonate, 4,5-dimethylene ethylene carbonate, vinyl ethylene carbonate, and 4,5-divinyl ethylene carbonate. Preferably compound (iii) comprises a cyclic carbonate containing at least one double bond, more preferred the electrolyte composition (C) contains at least one cyclic carbonate containing at least one double bond selected from vinylene carbonate, methyl vinylene carbonate, 4,5-dimethyl vinylene carbonate, methylene ethylene carbonate, and 4,5-dimethylene ethylene carbonate and most preferred compound (iii) comprises vinylene carbonate.

The minimum concentration of the at least compound (iii) is usually 0.005 wt.-%, preferably the minimum concentration is 0.01 wt.-% and more preferred the minimum concentration is 0.1 wt.-%, based on the total weight of electrolyte composition (C).

Additionally electrolyte composition (C) contains at least one compound (iv) selected from LiPO₂F₂, (CH₃CH₂O)₂P(O)F, LiN(SO₂CF₃)₂, LiN(SO₂F)₂, and LiBF₄, hereinafter also referred to as component (iv). Preferably compound (iv) comprises LiPO₂F₂ and/or (CH₃CH₂O)₂P(O)F, more preferred compound (iv) comprises LiPO₂F₂.

The minimum concentration of the at least compound (iv) is usually 0.005 wt.-%, preferably the minimum concentration is 0.01 wt.-% and more preferred the minimum concentration is 0.1 wt.-%, based on the total weight of electrolyte composition (C).

Electrolyte compositions (C) may contain e.g. vinylene carbonate and LiPO₂F₂ or may contain vinylene carbonate and LiBF₄, or may contain vinylene carbonate, LiPO₂F₂ and LiBF₄. Preferred Electrolyte compositions (C) contain vinylene carbonate and LiPO₂F₂.

Preferably the weight ratio of compounds (iii) to compounds (iv) in the electrolyte composition (C) is in the range of 1:20 to 20:1, more preferred 1:10 to 10:1 Electrolyte composition (C) usually contains a minimum total concentration of compounds (iii) and compounds (iv) in the electrolyte composition (C) of 0.01 wt.-%, based on the total weight of electrolyte composition (C), preferably 0.02 wt.-%, and more preferred 0.2 wt.-%, based on the total weight of electrolyte composition (C). The maximum value of the total concentration of compounds (iii) and compounds (iv) in the electrolyte composition (C) is usually 10 wt.-%, based on the total weight of electrolyte composition (C), preferably 5 wt.-%, and more preferred 3 wt.-%, based on the total weight of electrolyte composition (C). A usual range of the total concentration of compounds (iii) and compounds (iv) in the electrolyte composition (C) is 0.01 to 10 wt.-%, based on the total weight of electrolyte composition (C).

In one embodiment of the present invention formulations according to the present invention optionally contains one or more further additives (v). In case electrolyte composition (C) contains at least one further additive (v), electrolyte composition (C) contains preferably at least one further additive (v) selected from polymers, film forming additives, flame retardants, overcharging additives, wetting agents, HF and/or H₂O scavenger, stabilizer for LiPF₆ salt, ionic salvation enhancer, corrosion inhibitors, and gelling agents.

One class of additives (v) are polymers. Polymers may be selected from polyvinylidene fluoride, polyvinylidene-hexafluoropropylene copolymers, polyvinylidene-hexafluoropropylene-chlorotrifluoroethylene copolymers, Nafion, polyethylene oxide, polymethyl methacrylate, polyacrylonitrile, polypropylene, polystyrene, polybutadiene, polyethylene glycol, polyvinylpyrrolidone, polyaniline, polypyrrole and/or polythiophene. Polymers (v) may be added to a formulation according to the present invention in order to convert liquid formulations into quasi-solid or solid electrolytes and thus to improve solvent retention, especially during ageing. In this case they function as gelling agents.

One other class of additives (v) are flame retardants, hereinafter also being referred to as flame retardants (v). Examples of flame retardants (v) are organic phosphorous compounds like cyclophosphazenes, phosphoramides, alkyl and/or aryl tri-substituted phosphates, alkyl and/or aryl di- or tri-substituted phosphites, alkyl and/or aryl di-substituted phosphonates, alkyl and/or aryl tri-substituted phosphines, and fluorinated derivatives thereof.

One other class of additives (v) are HF— and/or H₂O scavengers. Examples of HF and/or H₂O scavenger are optionally halogenated cyclic and acyclic silylamines.

A further class of additives (v) are overcharge protection additives. Examples of overcharge protection additives are cyclohexylbenzene, o-terphenyl, p-terphenyl, and biphenyl and the like, preferred are cyclohexylbenzene and biphenyl.

Another class of additives (v) are film forming additives, also called SEI-forming additives. An SEI forming additive according to the present invention is a compound which decomposes on an electrode to form a passivation layer on the electrode which prevents degradation of the electrolyte and/or the electrode. In this way, the lifetime of a battery is significantly extended. Preferably the SEI forming additive forms a passivation layer on the anode. An anode in the context of the present invention is understood as the negative electrode of a battery. Preferably, the anode has a reduction potential of 1 Volt or less against lithium such as a lithium intercalating graphite anode. In order to determine if a compound qualifies as anode film forming additive, an electrochemical cell can be prepared comprising a graphite electrode and a metal counter electrode, and an electrolyte containing a small amount of said compound, typically from 0.1 to 10 wt.-% of the electrolyte composition, preferably from 0.2 to 5 wt.-% of the electrolyte composition. Upon application of a voltage between anode and lithium metal, the differential capacity of the electrochemical cell is recorded between 0.5 V and 2 V. If a significant differential capacity is observed during the first cycle, for example −150 mAh/V at 1 V, but not or essentially not during any of the following cycles in said voltage range, the compound can be regarded as SEI forming additive.

According to the present invention the electrolyte composition preferably contains at least one SEI forming additive. SEI forming additives are known to the person skilled in the art. More preferred the electrolyte composition contains at least one SEI forming selected from vinylene carbonate and its derivatives such as vinylene carbonate and methylvinylene carbonate; fluorinated ethylene carbonate and its derivatives such as monofluoroethylene carbonate, cis- and trans-difluorocarbonate; organic sultones such as propylene sultone, propane sultone and their derivatives; ethylene sulfite and its derivatives; oxalate comprising compounds such as lithium oxalate, oxalato borates including dimethyl oxalate, lithium bis(oxalate) borate, lithium difluoro (oxalato) borate, and ammonium bis(oxalato) borate, and oxalato phosphates including lithium tetrafluoro (oxalato) phosphate; and ionic compounds containing a cation of formula (I)

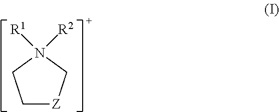

wherein

Z is CH₂ or NR¹³,

R¹ is selected from C₁ to C₆ alkyl,

R² is selected from —(CH₂)ᵤ—SO₃—(CH₂)—R¹⁴,

—SO₃— is —O—S(O)₂— or —S(O)₂—O—, preferably —SO₃— is —O—S(O)₂—,

u is an integer from 1 to 8, preferably u is 2, 3 or 4, wherein one or more CH₂ groups of the —(CH₂)ᵤ— alkylene chain which are not directly bound to the N-atom and/or the SO₃ group may be replaced by O and wherein two adjacent CH₂ groups of the —(CH₂)ᵤ— alkylene chain may be replaced by a C—C double bond, preferably the —(CH₂)ᵤ— alkylene chain is not substituted and u is an integer from 1 to 8, preferably u is 2, 3 or 4,

v is an integer from 1 to 4, preferably v is 0,

R¹³ is selected from C₁ to C₆ alkyl,

R¹⁴ is selected from C₁-C₂₀ alkyl, C₂-C₂₀ alkenyl, C₂-C₂₀ alkynyl, C₆-C₁₂ aryl, and C₆-C₂₄ aralkyl, which may contain one or more F, and wherein one or more CH₂ groups of alkyl, alkenyl, alkynyl and aralkyl which are not directly bound to the SO₃ group may be replaced by O, preferably R¹⁴ is selected from C₁-C₆ alkyl, C₂-C₄ alkenyl, and C₂-C₄ alkynyl, which may contain one or more F, and wherein one or more CH₂ groups of alkyl, alkenyl, alkynyl and aralkyl which are not directly bound to the SO₃ group may be replaced by O, preferred examples of R¹⁴ include methyl, ethyl, trifluoromethyl, pentafluoroethyl, n-propyl, n-butyl, n-hexyl, ethenyl, ethynyl, allyl or prop-1-yn-yl,

and an anion selected from bisoxalato borate, difluoro (oxalato) borate, [F_{z}B(CₙF_{2y+1})_{4-z}]⁻, [F_{y}P(CₙF₂ₙ₊₁)_{6-y}]⁻, [C_{y}F₂ₙ₊₁)₂P(O)O]⁻, [C_{y}F₂ₙ₊₁P(O)O₂]²⁻, [O—C(O)—CₙF₂ₙ₊₁]⁻, [O—S(O)₂—CₙF₂ₙ₊₁]⁻, [N(C(O)—CₙF₂ₙ₊₁)₂]⁻, [N(S(O)₂—CₙF₂n+₁)₂]⁻, [N(C(O)—CₙF₂ₙ₊₁)(S(O)₂—CₙF₂ₙ₊₁)]⁻, [N(C(O)—CₙF₂ₙ₊₁)(C(O)F)]⁻, [N(S(O)₂—CₙF₂ₙ₊₁)(S(O)₂F)]⁻, [N(S(O)₂F)₂]⁻, [C(C(O)—CₙF₂ₙ₊₁)₃]⁻, [C(S(O)₂—CₙF₂ₙ₊₁)₃]⁻, wherein n is an integer from 1 to 20, preferably up to 8, z is an integer from 1 to 4, and y is an integer from 1 to 6,

Preferred anions are bisoxalato borate, difluoro (oxalato) borate, [F₃B(CF₃)]⁻, [F₃B(C₂F₅)]⁻, [PF₆]⁻, [F₃P(C₂F₅)₃]⁻, [F₃P(C₃F₇)₃]⁻, [F₃P(C₄F₉)₃]⁻, [F₄P(C₂F₅)₂]⁻, [F₄P(C₃F₇)₂]⁻, [F₄P(C₄F₉)₂]⁻, [F₅P(C₂F₅)]⁻, [F₅P(C₃F₇)]⁻ or [F₅P(C₄F₉)]⁻, [(C₂F₅)₂P(O)O]⁻, [(C₃F₇)₂P(O)O]⁻ or [(C₄F₉)₂P(O)O]⁻. [C₂F₅P(O)O₂]²⁻, [C₃F₇P(O)O₂]²⁻, [C₄F₉P(O)O₂]²⁻, [O—C(O)CF₃]⁻, [O—C(O)C₂F₅]⁻, [O—C(O)C₄F₉]⁻, [O—S(O)₂CF₃]⁻, [O—S(O)₂C₂F₅]⁻, [N(C(O)C₂F₅)₂]⁻, [N(C(O)(CF₃)₂]⁻, [N(S(O)₂CF₃)₂]⁻, [N(S(O)₂C₂F₅)₂]⁻, [N(S(O)₂C₃F₇)₂]⁻, [N(S(O)₂CF₃) (S(O)₂C₂F₅)]⁻, [N(S(O)₂C₄F₉)₂]⁻, [N(C(O)CF₃)(S(O)₂CF₃)]⁻, [N(C(O)C₂F₅)(S(O)₂CF₃)]⁻ or [N(C(O)CF₃)(S(O)₂—C₄F₉)]⁻, [N(C(O)CF₃)(C(O)F)]⁻, [N(C(O)C₂F₅)(C(O)F)]⁻, [N(C(O)C₃F₇)(C(O)F)]⁻, [N(S(O)₂CF₃)(S(O)₂F)]⁻, [N(S(O)₂C₂F₅)(S(O)₂F)]⁻, [N(S(O)₂C₄F₉)(S(O)₂F)]⁻, [C(C(O)CF₃)₃]⁻, [C(C(O)C₂F₅)₃]⁻ Or [C(C(O)C₃F₇)₃]⁻, [C(S(O)₂CF₃)₃]⁻, [C(S(O)₂C₂F₅)₃]⁻, and [C(S(O)₂C₄F₉)₃]⁻

More preferred the anion is selected from bisoxalato borate, difluoro (oxalato) borate, CF₃SO₃—, and [PF₃(C₂F₅)₃]⁻.

The term “C₂-C₂₀ alkenyl” as used herein refers to an unsaturated straight or branched hydrocarbon group with 2 to 20 carbon atoms having one free valence. Unsaturated means that the alkenyl group contains at least one C—C double bond. C₂-C₆ alkenyl includes for example ethenyl, 1-propenyl, 2-propenyl, 1-n-butenyl, 2-n-butenyl, iso-butenyl, 1-pentenyl, 1-hexenyl, 1-heptenyl, 1-octenyl, 1-nonenyl, 1-decenyl and the like. Preferred are C₂-C₁₀ alkenyl groups, more preferred are C₂-C₆ alkenyl groups, even more preferred are C₂-C₄ alkenyl groups and in particular ethenyl and 1-propen-3-yl (allyl).

The term “C₂-C₂₀ alkynyl” as used herein refers to an unsaturated straight or branched hydrocarbon group with 2 to 20 carbon atoms having one free valence, wherein the hydrocarbon group contains at least one C—C triple bond. C₂-C₆ alkynyl includes for example ethynyl, 1-propynyl, 2-propynyl, 1-n-butinyl, 2-n-butynyl, iso-butinyl, 1-pentynyl, 1-hexynyl, -heptynyl, 1-octynyl, 1-nonynyl, 1-decynyl and the like and the like. Preferred are C₂-C₁₀ alkynyl, more preferred are C₂-C₆ alkynyl, even more preferred are C₂-C₄ alkynyl, in particular preferred are ethynyl and 1-propyn-3-yl (propargyl).

The term “C₆-C₁₂ aryl” as used herein denotes an aromatic 6- to 12-membered hydrocarbon cycle or condensed cycles having one free valence. Examples of C₆-C₁₂ aryl are phenyl and naphtyl. Preferred is phenyl.

The term “C₇-C₂₄ aralkyl” as used herein denotes an aromatic 6- to 12-membered aromatic hydrocarbon cycle or condensed aromatic cycles substituted by one or more C₁-C₆ alkyl. The C₇-C₂₄ aralkyl group contains in total 7 to 24 C-atoms and has one free valence. The free valence may be located at the aromatic cycle or at a C₁-C₆ alkyl group, i.e. C₇-C₂₄ aralkyl group may be bound via the aromatic part or via the alkyl part of the aralkyl group. Examples of C₇-C₂₄ aralkyl are methylphenyl, benzyl, 1,2-dimethylphenyl, 1,3-dimethylphenyl, 1,4-dimethylphenyl, ethylphenyl, 2-propylphenyl, and the like.

Compounds of formula (I) and their preparation are described in detail in WO 2013/026854 A1. Examples of compounds of formula (II) which are preferred according to the present invention are disclosed on page 12, line 21 to page 15, line 13 of WO 2013/026854 A1.

A compound added may have more than one effect in the electrolyte composition (C) and the device comprising the electrolyte composition (C). E.g. lithium oxalato borate may be added as additive (v) enhancing the SEI formation but may also be function as conducting salt (ii) or as compound (iii).

In one embodiment electrolyte composition (C) contains

in total 35 to 99.8 wt.-% of solvent (i), preferred 55 to 98.9 wt.-%,

in total 0.1 to 25 wt.-% of lithium conducting salt (ii), preferred 10 to 20% by weight,

in total 0.005 to 5 wt.-% of compound (iii), preferred 0.01 to 5% by weight, even more preferred 0.1 to 5 wt.-%,

in total 0.005 to 5 wt.-% of compound (iv), preferred 0.01 to 5% by weight, even more preferred 0.1 to 5 wt.-%,

zero to in total 30 wt.-% of additive(s) (v), preferred 1 to 10 wt.-%, and

zero to less than 1 wt.-% of halogenated organic carbonate(s), preferably zero to less than 0.5 wt.-%, more preferred zero to less than 0.1 wt.-%, even more preferred zero to less than 0.01 wt.-% and most preferred zero to less than 0.001 wt.-% of halogenated organic carbonate(s).

Percentages referring to the total weight of electrolyte composition (C).

In one embodiment of the present invention, the water content of the electrolyte composition (C) is preferably below 100 ppm, based on the weight of the respective inventive formulation, more preferred below 50 ppm, most preferred below 30 ppm. The water content may be determined by titration according to Karl Fischer, e.g. described in detail in DIN 51777 or ISO760: 1978. The minimum water content of electrolyte compositions (C) may be selected from 3 ppm, preferably 5 ppm.

In one embodiment of the present invention, the HF-content of the electrolyte composition (C) is preferably below 100 ppm, based on the weight of the respective inventive formulation, more preferred below 50 ppm, most preferred below 30 ppm. The minimum HF content of inventive formulations may be selected from 5 ppm, preferably 10 ppm. The HF content may be determined by titration.

Electrolyte composition (C) is preferably liquid at working conditions; more preferred it is liquid at 1 bar and 25° C., even more preferred the electrolyte composition is liquid at 1 bar and −15° C., in particular the electrolyte composition is liquid at 1 bar and −30° C., even more preferred the electrolyte composition is liquid at 1 bar and −50° C. Such liquid electrolyte compositions are particularly suitable for outdoor applications, for example for use in automotive batteries.

Electrolyte composition (C) may be prepared by methods which are known to the person skilled in the field of the production of electrolytes, generally by dissolving the conductive salt (ii) in the corresponding solvent or solvent mixture (i) and adding the compounds (iii) and (iv) and optionally further additive(s) (v), as described above.

The inventive electrochemical cell comprises
(A) an anode comprising at least one anode active material;
(B) a cathode comprising at least one cathode active material different from LiCoO₂ and selected from lithium intercalating transition metal oxides with layered structure, lithium intercalating manganese-containing spinels, and lithiated transition metal phosphates; and
(C) an electrolyte composition as described above or as described as being preferred.

The electrochemical cell may be a lithium battery, a double layer capacitor, or a lithium ion capacitor. The general construction of such electrochemical devices is known and is familiar to the person skilled in this art—for batteries, for example, in Linden's Handbook of Batteries (ISBN 978-0-07-162421-3).

Preferably the electrochemical cell is a lithium battery. The term “lithium battery” as used herein means an electrochemical cell, wherein the anode comprises lithium metal or lithium ions sometime during the charge/discharge of the cell. The anode may comprise lithium metal or a lithium metal alloy, a material occluding and releasing lithium ions, or other lithium containing compounds; e.g. the lithium battery may be a lithium ion battery, a lithium/sulphur battery, or a lithium/selenium sulphur battery.

In particular preferred embodiments the electrochemical cell is a lithium ion battery, i.e. a secondary lithium ion electrochemical cell comprising a cathode (A) comprising a cathode active material that can reversibly occlude and release lithium ions and an anode (B) comprising an anode active material that can reversibly occlude and release lithium ions. The terms “secondary lithium ion electrochemical cell” and “(secondary) lithium ion battery” are used interchangeably within the present invention.

Anode (A) comprises an anode active material that can reversibly occlude and release lithium ions or is capable to form an alloy with lithium. In particular carbonaceous material that can reversibly occlude and release lithium ions can be used as anode active material. Carbonaceous materials suited are crystalline carbon such as a graphite materials, more particularly, natural graphite, graphitized cokes, graphitized MCMB, and graphitized MPCF; amorphous carbon such as coke, mesocarbon microbeads (MCMB) fired below 1500° C., and mesophase pitch-based carbon fiber (MPCF); hard carbon and carbonic anode active material (thermally decomposed carbon, coke, graphite) such as a carbon composite, combusted organic polymer, and carbon fiber.

Further examples of anode active materials are lithium metal and materials containing an element capable of forming an alloy with lithium. Non-limiting examples of materials containing an element capable of forming an alloy with lithium include a metal, a semimetal, or an alloy thereof. It should be understood that the term “alloy” as used herein refers to both alloys of two or more metals as well as alloys of one or more metals together with one or more semimetals. If an alloy has metallic properties as a whole, the alloy may contain a nonmetal element. In the texture of the alloy, a solid solution, a eutectic (eutectic mixture), an intermetallic compound or two or more thereof coexist. Examples of such metal or semimetal elements include, without being limited to, titanium (Ti), tin (Sn), lead (Pb), aluminum, indium (In), zinc (Zn), antimony (Sb), bismuth (Bi), gallium (Ga), germanium (Ge), arsenic (As), silver (Ag), hafnium (Hf), zirconium (Zr) yttrium (Y), and silicon (Si). Metal and semimetal elements of Group 4 or 14 in the long-form periodic table of the elements are preferable, and especially preferable are titanium, silicon and tin, in particular silicon. Examples of tin alloys include ones having, as a second constituent element other than tin, one or more elements selected from the group consisting of silicon, magnesium (Mg), nickel, copper, iron, cobalt, manganese, zinc, indium, silver, titanium (Ti), germanium, bismuth, antimony and chromium (Cr). Examples of silicon alloys include ones having, as a second constituent element other than silicon, one or more elements selected from the group consisting of tin, magnesium, nickel, copper, iron, cobalt, manganese, zinc, indium, silver, titanium, germanium, bismuth, antimony and chromium.

A further possible anode active material are silicon based materials. Silicon based materials include silicon itself, e.g. amorphous and crystalline silicon, silicon containing compounds, e.g. SiOₓ with 0<x<1.5 and Si alloys, and compositions containing silicon and/or silicon containing compounds, e.g. silicon/graphite composites and carbon coated silicon containing materials. Silicon itself may be used in different forms, e.g. in the form of nanowires, nanotubes, nanoparticles, films, nanoporous silicon or silicon nanotubes. The silicon may be deposited on a current collector. Current collector may be selected from coated metal wires, a coated metal grid, a coated metal web, a coated metal sheet, a coated metal foil or a coated metal plate. Preferably, current collector is a coated metal foil, e.g. a coated copper foil. Thin films of silicon may be deposited on metal foils by any technique known to the person skilled in the art, e.g. by sputtering techniques. One method of preparing thin silicon film electrodes are described in R. Elazari et al.; Electrochem. Comm. 2012, 14, 21-24.

Other possible anode active materials are lithium ion intercalating oxides of Ti.

Preferably the anode active material comprises carbonaceous material that can reversibly occlude and release lithium ions, particularly preferred the carbonaceous material that can reversibly occlude and release lithium ions is selected from crystalline carbon, hard carbon and amorphous carbon, and particularly preferred is graphite. It is also preferred that the anode active material comprises silicon based anode active materials. It is further preferred embodiment the anode active material comprises lithium ion intercalating oxides of Ti. It is in particular preferred to select the anode active material comprises a silicon based anode active material.

The inventive electrochemical cell comprises a cathode (B) comprising at least one cathode active material which is different from LiCoO₂ and is selected from lithium intercalating transition metal oxides with layered structure, lithium intercalating manganese-containing spinels, and lithiated transition metal phosphates. In one embodiment of the invention more than 50 wt.-% of the cathode active material(s) present in the electrochemical is different from LiCoO₂, preferred more than 70 wt.-%, more preferred more than 90 wt.-%, even more preferred more than 90 wt.-% and most preferred more than 99 wt.-% of the cathode active material(s) present in the electrochemical cell is different from LiCoO₂, based on the total weight of cathode active material present in the electrochemical cell. According to another embodiment of the invention all cathode active material present in cathode (B) is the selected from lithium intercalating transition metal oxides with layered structure, lithium intercalating manganese-containing spinels, and lithiated transition metal phosphates.

One example of lithium transition metal oxides with layered structure are compounds having the general formula (I) Li_{(1+y)}[NiₐCO_{b}Mn_{c}]_{(1-y)}O₂₊ₑ wherein y is 0 to 0.3, a, b and c may be same or different and are independently 0 to 0.8, wherein a+b+c=1, and −0.1≤e≤0. These materials are also abbreviated as NCM. Preferably the molar ratio of Ni:(Co+Mn) is at least 1:1. It is also preferred that a, b and c are >zero, e.g. a, b and c are at least 0.01.

The compounds of general formula (I) may contain one or more additional metals M, e.g. selected from Na, K, Al, Mg, Ca, Cr, V, Mo, Ti, Fe, W, Nb, Zr, and Zn in minor amounts. These metals are also called “dopants” or “doping metal” since they are usually present at minor amounts, e.g. at maximum 1 mol.-% based on the total amount of metal except lithium present in the transition metal oxide. In case one or more metals M are present, they are usually present in an amount of at least 0.01 mol-% or at least 0.1 mol-% based on the total amount of metal except lithium present in the transition metal oxide.

Another example of lithium transition metal oxides with layered structure are lithium intercalating mixed oxides of Ni, Co and Al and optionally Mn.

Preferred lithium transition metal oxides with layered structure are compounds of general formula(I) Li_{(1+y)}[NiₐCo_{b}Mn_{c}]_{(1-y)}O₂₊ₑ wherein y is 0 to 0.3, a, b and c may be same or different and are independently 0 to 0.8, a+b+c=1, −0.1<e<0; and wherein the molar ratio of Ni:(Co+Mn) is at least 1:1. More preferred are compounds of formula(I) wherein y is 0 to 0.3, a is 0.5 to 0.8, b and c may be same or different and are independently 0 to 0.5, a+b+c=1, −0.1≤e≤0, and wherein the molar ratio of Ni:(Co+Mn) is at least 1:1. It is particularly preferred, that b and c are independently >zero to 0.5, preferably b and c are independently 0.01 to 0.5. Examples of Ni-rich materials are Li[Ni_{0.8}Co_{0.1}Mn_{0.1}]O₂ (NCM 811), Li[Ni_{0.6}Co_{0.2}Mn_{0.2}]O₂ (NCM 622), and Li[Ni_{0.5}Co_{0.2}Mn_{0.3}]O₂ (NCM 523).

Preferred lithium intercalating mixed oxides of Ni, Co and Al have the general formula (II) Li[NiₕCoᵢAlⱼ]O₂ wherein h is 0.7 to 0.95, preferred 0.7 to 0.9, more preferred 0.8 to 0.87, and most preferred 0.8 to 0.85; i is 0.03 to 0.20, preferred 0.15 to 0.20; and j is 0.02 to 10, preferred 0.02 to 1, more preferred 0.02 to 0.1, and most preferred 0.02 to 0.03. These compounds are also abbreviated as NCA.

Preferred compounds of formula (II) are such wherein h is 0.7 to 0.95, i is 0.03 to 0.20, j is 0.02 to 0.1 and h+i+j=1.

Examples of compounds of formula (II) are LiNi_{0.86}Co_{0.12}Al_{0.02}O₂, LiNi_{0.815}Co_{0.15}Al_{0.035}O₂, LiNi_{0.90}Co_{0.08}Al_{0.02}O₂, and LiNi_{0.76}Co_{0.14}Al_{0.1}O₂.

One class of lithium intercalating mixed oxides of Ni, Co, and Al contain at least additionally Mn. These compounds are also abbreviated as NCAM. An example of lithium intercalating mixed oxides of Ni, Co, Al, and Mn is LiNi_{0.82}Co_{0.14}Al_{0.03}Mn_{0.01}O₂.

The lithium intercalating mixed oxides of Ni, Co, Al and optionally Mn including the compounds of general formula (II) may contain one or more additional metals M as dopants, e.g. selected from Na, K, Mg, Ca, Cr, V, Mo, Ti, Fe, W, Nb, Zr, and Zn.

Examples of manganese-containing spinels are compounds of general formula L₁₊ₜM₂₋ₜO_{4-d} wherein d is 0 to 0.4, t is 0 to 0.4 and M is Mn and at least one further metal selected from Co and Ni.

Examples of lithiated transition metal phosphates are LiMnPO₄, LiFePO₄ and LiCoPO₄.

In a preferred embodiment of the present invention cathode (B) contains at least one cathode active material selected from lithium intercalating mixed oxides of Ni, Co and Al, and lithium transition metal oxides with layered structure containing Ni, Co and Mn as described above, preferred lithium transition metal oxides with layered structure containing Ni, Co and Mn are those wherein the molar ratio of Ni:(Co+Mn) is at least 1:1, in particular preferred are Li[Ni_{0.8}Co_{0.1}Mn_{0.1}]O₂ (NCM 811), Li[Ni_{0.6}Co_{0.2}Mn_{0.2}]O₂ (NCM 622), and Li[Ni_{0.5}Co_{0.2}Mn_{0.3}]O₂ (NCM 523).

Cathode (B) may contain further components like binders and electrically conductive materials such as electrically conductive carbon. For example, cathode (B) may comprise carbon in a conductive polymorph, for example selected from graphite, carbon black, carbon nanotubes, graphene or mixtures of at least two of the aforementioned substances. Examples of binders used in cathode (B) are organic polymers like polyethylene, polyacrylonitrile, polybutadiene, polypropylene, polystyrene, polyacrylates, polyvinyl alcohol, polyisoprene and copolymers of at least two comonomers selected from ethylene, propylene, styrene, (meth)acrylonitrile and 1,3-butadiene, especially styrene-butadiene copolymers, and halogenated (co)polymers like polyvinlyidene chloride, polyvinly chloride, polyvinyl fluoride, polyvinylidene fluoride (PVdF), polytetrafluoroethylene, copolymers of tetrafluoroethylene and hexafluoropropylene, copolymers of tetrafluoroethylene and vinylidene fluoride and polyacrylnitrile.

Anode (A) and cathode (B) may be made by preparing an electrode slurry composition by dispersing the electrode active material, a binder, optionally a conductive material and a thickener, if desired, in a solvent and coating the slurry composition onto a current collector. The current collector may be a metal wire, a metal grid, a metal web, a metal sheet, a metal foil or a metal plate. Preferred the current collector is a metal foil, e.g. a copper foil or aluminum foil.

The inventive electrochemical cells may contain further constituents customary per se, for example separators, housings, cable connections etc. The housing may be of any shape, for example cuboidal or in the shape of a cylinder, the shape of a prism or the housing used is a metal-plastic composite film processed as a pouch. Suited separators are for example glass fiber separators and polymer-based separators like polyolefin or Nafion separators.

Several inventive electrochemical cells may be combined with one another, for example in series connection or in parallel connection. Series connection is preferred. The present invention further provides for the use of inventive electrochemical cells as described above in devices, especially in mobile devices. Examples of mobile devices are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven staplers. But the inventive electrochemical cells can also be used for stationary energy stores.

The present invention is further illustrated by the following examples that do not, however, restrict the invention.

I. Electrolyte Compositions

A base electrolyte composition was prepared containing 12.7 wt % of LiPF₆, 26.2 wt % of ethylene carbonate (EC), and 61.1 wt % of ethyl methyl carbonate (EMC) (EL base 1), based on the total weight of EL base 1. To this base electrolyte formulation different amounts of fluoroeth-ylene carbonate (FEC), vinylene carbonate (VC), LiBF₄, and LiPO₂F₂ were added. The exact compositions are summarized in Tables 1 to 6. In the Tables concentrations are given as wt.-% based on the total weight of the electrolyte composition.

II. Production of Anode Electrode Tape

IIa) Silicon/Carbon Black Anodes

Nanosized silicon powder (APS≈100 nm, Plasma Synthesized, Alfa Aesar, A Johnson Matthey Company) and carbon black were thoroughly mixed. An aqueous solution of poly(acrylic acid) (PAA) was added as binder to the mixture of the silicon power and the carbon black to prepare a smooth slurry for electrode preparation. The thus obtained black slurry was cast onto a sheet of copper foil (thickness=18 μm) with a doctor blade and pre-dried at 100° C. under vacuum for 8 h. The sample loading for electrodes on Cu foil was fixed to be 0.8 mg cm². This anode is hereinafter also referred to as Si anode.

IIb) Silicon Suboxide/Graphite Anodes

Silicon suboxide, graphite and carbon black were thoroughly mixed. CMC (carboxymethyl cellulose) aqueous solution and SBR (styrene butadiene rubber) aqueous solution were used as binder. The mixture of silicon suboxide, graphite and carbon black was mixed with the binder solutions and an adequate amount of water was added to prepare a suitable slurry for electrode preparation. The thus obtained slurry was coated by using a roll coater onto copper foil (thickness=18 μm) and dried under ambient temperature. The sample loading for electrodes on Cu foil was fixed to be 5 mg cm⁻² with 1.25 g cm⁻³ density.

IIc) Graphite Anodes

Graphite and carbon black were thoroughly mixed. CMC (carboxymethyl cellulose) aqueous solution and SBR (styrene butadiene rubber) aqueous solution were used as binder. The mixture of graphite and carbon black was mixed with the binder solutions and an adequate amount of water was added to prepare a suitable slurry for electrode preparation. The thus obtained slurry was coated by using a roll coater onto copper foil (thickness=10 μm) and dried under ambient temperature. The sample loading for electrodes on Cu foil was fixed to be 5.5 mg cm⁻² with 1.4 g cm⁻³ density.

IId) Silicon Suboxide/Graphite Anodes for Pouch Cell

Slurry preparation was similar as described above in lilb). The thus obtained slurry was coated by using a roll coater onto copper foil (thickness=10 μm) and dried under ambient temperature. The sample loading for electrodes on Cu foil was fixed to be 7 mg cm⁻² with 1.5 g cm⁻³ density.

III. Fabrication of Cathode Tapes

IIIa) NCM 523

Lithium containing mixed Ni, Co and Mn oxide (NCM 523, manufactured by BASF) was used as a cathode active material and mixed with carbon black. The mixture of NCM 523 and carbon black was mixed with Polyvinylidene fluoride (PVdF) binders, and an adequate amount of N-methylpyrrolidinone (NMP) was added to prepare a suitable slurry for electrode preparation. The thus obtained slurry was coated by using a roll coater onto aluminum foil (thickness=15 μm) and dried under ambient temperature. This electrode tape was then kept at 130° C. under vacuum for 8 h to be ready to be used. The thickness of the cathode active material was found to be 72 μm, which was corresponding to 12.5 mg/cm² of the loading amount.

IIIb) NCA

Lithium containing mixed Ni, Co and Al oxide Ni_{0.82}Co_{0.16}Al_{0.02} was used as a cathode active material and mixed with carbon black. The mixture of NCA and carbon black was mixed with polyvinylidene fluoride (PVdF) binders, and an adequate amount of N-methylpyrrolidinone (NMP) was added to prepare a suitable slurry for electrode preparation. The thus obtained slurry was coated by using a roll coater onto aluminum foil and dried under ambient temperature. This electrode tape was then kept at 130° C. under vacuum for 8 h to be ready to be used. The density of the cathode was found to be 3.4 g·cm⁻³, which was corresponding to 11 mg·cm⁻² of the loading amount of one side.

IV. Fabrication of the Test Cells

Coin-type half cells (20 mm in diameter and 3.2 mm in thickness) comprising a Si anode prepared as described above in IIa) or silicon suboxide/graphite composite anode prepared as described above in IIb) and lithium metal as working and counter electrode, respectively, were assembled and sealed in an Ar-filled glove box. In addition, the cathode and anode described above and a separator were superposed in order of anode//separator//Li foil to produce a half coin cell. Thereafter, 0.2 mL of the different nonaqueous electrolyte compositions were introduced into the coin cell.

Coin-type Full cells (20 mm in diameter and 3.2 mm in thickness) comprising a NCM 523 cathode prepared as described above in IIIa) and silicon suboxide/graphite composite anode prepared as described above in IIb) as cathode and anode electrode, respectively, were assem-bled and sealed in an Ar-filled glove box. In addition, the cathode and anode described above and a separator were superposed in order of cathode//separator//anode to produce a coin full cell. Thereafter, 0.15 mL of the different nonaqueous electrolyte compositions were introduced into the coin cell.

Pouch cells (350 mAh) comprising a NCM 523 electrode prepared as described above in IIIa). and graphite electrode as described above in IIc) as cathode and anode, respectively, were assembled and sealed in an Ar-filled glove box. In addition, the cathode and anode described above and a separator were superposed in order of cathode//separator//anode to produce a several layers pouch cell. Thereafter, 3 mL of the different nonaqueous electrolyte compositions were introduced into the Laminate pouch cell.

Pouch cells (200 mAh) comprising a NCA electrode prepared as described above in IIIb) as cathode and a silicon suboxide/graphite electrode as described above in) as anode, were assembled and sealed in an Ar-filled glove box. In addition, the cathode and anode described above and a separator were superposed in order of cathode//separator//anode to produce a several layers pouch cell. Thereafter, 7 mL of the different nonaqueous electrolyte compositions were introduced into the laminate pouch cell.

V. Cycle Stability of the Test Cells at Room Temperature

Va) Cycle Stability of Coin Halfcells Comprising Si Anode

Coin half cells prepared comprising a Si anode and lithium metal were tested in a voltage range between 0.6 V to 0.03 V at room temperature. For the initial 2 cycles, the initial lithiation was conducted in the CC-CV mode, i.e., a constant current (CC) of 0.05 C was applied until reaching 0.01 C. After 5 min resting time, oxidative delithiation was carried out at constant current of 0.05 C up to 1 V. For the cycling, the current density increased to 0.5 C. The results are summarized in Table 1. [%] capacity retention after 100 cycles is based on the capacity retention after the second cycle.

TABLE 1
Cycle stability of coin halfcells comprising Si anode at room temperature

| | | EL | | | | | Capacity after |
|---|---|---|---|---|---|---|---|
| | Electrolyte | base | VC | FEC | LiPO₂F₂ | LiBF₄ | 100 cycles |
| Example | solution | 1 | [%] | [%] | [%] | [%] | [%] |
| 1 (Inventive) | EL 1 | 97 | 2 | 0 | 1 | 0 | 78 |
| 2 (Comparative) | EL 2 | 99 | 0 | 0 | 1 | 0 | 70 |
| 3 (Inventive) | EL 3 | 96.6 | 2 | 0 | 0.5 | 0.9 | 85 |
| 4 (Comparative) | EL 4 | 100 | 0 | 0 | 0 | 0 | 48 |
| 5 (Comparative) | EL 5 | 98 | 0 | 2 | 0 | 0 | 67 |
| 6 (Comparative) | EL 6 | 97 | 0 | 2 | 1 | 0 | 66 |

Vb) Cycle Stability of Coin Halfcells Comprising Silicon Suboxide/Graphite Composite Anode

Coin half cells prepared comprising a silicon suboxide/graphite composite anode and lithium metal were tested in a voltage range between 1 V to 0.03 V at room temperature. For the initial 2 cycles, the initial lithiation was conducted in the CC-CV mode, i.e., a constant current (CC) of 0.05 C was applied until reaching 0.01 C. After 5 min resting time, oxidative delithiation was carried out at constant current of 0.05 C up to 1 V. For the cycling, the current density increased to 0.5 C. The results are summarized in Table 2. [%] capacity retention after 100 cycles is based on the capacity retention after the second cycle.

TABLE 2
Cycle stability of coin halfcells comprising silicon
suboxide/graphite anode at room temperature

| | | | | | | Capacity |
|---|---|---|---|---|---|---|
| | Elec- | EL | | | | after 100 |
| | trolyte | base | VC | FEC | LiPO₂F₂ | cycles |
| Example | solution | 1 | [%] | [%] | [%] | [%] |
| 1 (Inventive) | EL 1 | 97 | 2 | 0 | 1 | 91 |
| 2 (Comparative) | EL 4 | 100 | 0 | 0 | 0 | 79 |
| 3 (Comparative) | EL 5 | 98 | 0 | 2 | 0 | 86 |
| 4 (Comparative) | EL 6 | 97 | 0 | 2 | 1 | 82 |

Vc) Cycle Stability of Coin Fullcell Comprising NCM523//Silicon Suboxide/Graphite Composite Anode

Coin fullcells prepared comprising a NCM523 cathode and silicon suboxide/graphite composite anode were tested in a voltage range between 4.2 V to 2.5 V at room temperature. For the initial 2 cycles, the initial charge was conducted in the CC-CV mode, i.e., a constant current (CC) of 0.05 C was applied until reaching 0.01 C. After 5 min resting time, discharge was carried out at constant current of 0.05 C to 2.5 V. For the cycling, the current density increased to 0.5 C. The results are summarized in Table 3. [%] capacity retention after 200 cycles is based on the capacity retention after the second cycle.

TABLE 3
Cycle stability of the coin fullcells at elevated temperature

| | | | | | | Capacity |
|---|---|---|---|---|---|---|
| | Elec- | EL | | | | after 200 |
| | trolyte | base | VC | FEC | LiPO₂F₂ | cycles |
| Example | solution | 1 | [%] | [%] | [%] | [%] |
| 1 (Inventive) | EL 1 | 97 | 2 | 0 | 1 | 87 |
| 2 (Comparative) | EL 4 | 100 | 0 | 0 | 0 | 63 |
| 3 (Comparative) | EL 6 | 97 | 0 | 2 | 1 | 81 |

Vd) Cycle Stability of Coin Fullcells at 45° C.

Electrochemical cycle tests were carried out to see the fading of the discharge capacity of the test cells during charge-discharge cycling at 45° C. For the initial 2 cycles, the charge was conducted in the CC-CV mode, i.e., a constant current (CC) of 0.05 C was applied until reaching 0.01 C. After 5 min resting time, discharge was carried out at constant current of 0.05 C to 2.5 V. For the 3^{rd} and 4^{th} cycles, the current density increased to 0.5 C and the cut-off voltage range was between 4.2 to 2.5 V.

After the formation cycle, the tests were carried out in a constant temperature oven, the temperature of which was set to be 45° C. For charging, CCCV mode was employed; the current density was 0.5 C and the cut-off voltage was 4.2 V. When the current reached 0.1 C, the charging stopped. After 5 min resting time, discharging started. For discharging, CC mode was employed; the current density was 0.5 C, and the cut-off voltage was 2.5 V. The result was summarized in Table 2. [%] capacity retention after 200 cycles is based on the capacity retention after the second cycle.

TABLE 4
Cycling at 45° C.

| | | | | | | Capacity |
|---|---|---|---|---|---|---|
| | Elec- | EL | | | | after 200 |
| | trolyte | base | VC | FEC | LiPO₂F₂ | cycles |
| Example | solution | 1 | [%] | [%] | [%] | [%] |
| 1 (Inventive) | EL 1 | 97 | 2 | 0 | 1 | 75 |
| 2 (Comparative) | EL 4 | 100 | 0 | 0 | 0 | 65 |
| 3 (Comparative) | EL 5 | 98 | 0 | 2 | 0 | 74 |
| 4 (Comparative) | EL 7 | 90 | 0 | 10 | 0 | 72 |

VI Evaluation of High-Temperature Storability

VIa) Pouch Cells Comprising NCM 523 Cathode//Graphite Anode

The pouch cells prepared comprising a NCM 523 cathode and graphite anode was charged to 4.25 V at a constant current of 0.1 C and then charged at a constant voltage of 4.25 V until the current value reached 0.01 C after the formation cycles. These cells was stored at 60° C. for 30 days and then cooled. The cells was measured by Archimedes method to identify the volume change before and after storage. The volume change of the cells is determined as the ratio of the cell volume before and after storage of cells and is given in % based on the volume before storage. The open circuit voltage (OCV) change is the percentage of the OCV value after storage based on the OCV value before storage.

TABLE 5
Volume change and OCV change after 30 days at 60° C. storage

| | | | | | | Volume | OCV |
|---|---|---|---|---|---|---|---|
| | | | | | | change after | change after |
| | | | | | | 30 days | 30 days |
| | | EL | | | | at 60° C. | at 60° C. |
| | Electrolyte | base | VC | FEC | LiPO₂F₂ | storage | storage |
| Example | solution | 1 | [%] | [%] | [%] | [%] | [%] |
| 1 (inventive) | EL 1 | 97 | 2 | 0 | 1 | 123 | 95.6 |
| 2 (Comparative) | EL 5 | 98 | 0 | 2 | 0 | 159 | 94.6 |
| 3 (Comparative) | EL 7 | 90 | 0 | 10 | 0 | 193 | 94.8 |

VIb) Pouch Cells Comprising NCA Cathode//Silicon Suboxide/Graphite Composite Anode

These cells was stored at 60° C. for 30 days at 4.2 V and then cooled. The cells were measured by Archimedes method to identify the volume change during storage. The gas amount of the cells is determined as the ratio of the volume change before and after storage of cells and is given in % based on the gas amount of pouch cell with EL 4 electrolyte (100% EL base 1). The results are summarized in Table 6.

TABLE 6
Volume change after 30 days at 60° C. storage

| | | | | | | Volume |
|---|---|---|---|---|---|---|
| | | | | | | change |
| | | | | | | after 30 |
| | | | | | | days at |
| | Elec- | EL | | | | 60° C. |
| | trolyte | base | VC | FEC | LiPO₂F₂ | storage |
| Example | solution | 1 | [%] | [%] | [%] | [%] |
| 1 (inventive) | EL 1 | 97 | 2 | 0 | 1 | 28 |
| 2 (Comparative) | EL 4 | 100 | 0 | 0 | 0 | 100 |
| 3 (Comparative) | EL 8 | 98 | 2 | 0 | 0 | 154 |
| 4 (Comparative) | EL 5 | 98 | 0 | 2 | 0 | 129 |
| 5 (Comparative) | EL 9 | 96 | 2 | 2 | 0 | 180 |
| 6 (Comparative) | EL 7 | 90 | 0 | 10 | 0 | 277 |

1. An electrochemical cell comprising
(A) an anode comprising at least one anode active material;
(B) a cathode comprising at least one cathode active material selected from lithium intercalating transition metal oxides with layered structure having the general formula (I) Li_{(1+y)}[NiₐCo_{b}Mn_{c}]_{(1-y)}O₂₊ₑ wherein y is 0 to 0.3, a, b and c may be same or different and are independently >0 to 0.8, a+b+c=1, −0.1≤e≤0, and wherein the molar ratio of Ni:(Co+Mn) is at least 1:1; and lithium intercalating mixed oxides of Ni, Co and Al and optionally Mn; and
(C) an electrolyte composition containing
(i) at least one aprotic organic solvent;
(ii) at least one lithium conducting salt;
(iii) at least one compound selected from lithium bis(oxalato) borate, lithium difluorooxalato borate, and cyclic carbonates containing at least one double bond;
(iv) at least one compound selected from LiPO₂F₂, (CH₃CH₂O)₂P(O)F, LiN(SO₂CF₃)₂, LiN(SO₂F)₂, and LiBF₄; and
(v) optionally one or more further additives;
wherein the electrolyte composition (C) contains essentially no halogenated organic carbonate.

2. The electrochemical cell according to claim 1, wherein the anode active material comprises a silicon based anode active material.

3. The electrochemical cell according to claim 1, wherein the cathode active material is selected from compounds of formula (I) containing one or more additional metals M selected from Na, K, Al, Mg, Ca, Cr, V, Mo, Ti, Fe, W, Nb, Zr, and Zn.

4. The electrochemical cell according to claim 3, wherein the cathode active material is selected from transition metal oxides with layered structure having the general formula (I)Li_{(1+y)}[NiₐCo_{b}Mn_{c}]_{(1-y)}O₂₊ₑ wherein y is 0 to 0.3, a is 0.5 to 0.8, b and c may be same or different and are independently >0 to 0.5 wherein a+b+c=1, −0.1≤e≤0, and wherein the ratio of Ni:(Co+Mn) is at least 1:1.

5. The electrochemical cell according to claim 1, wherein the cathode active material is selected from lithium intercalating mixed oxides of Ni, Co and Al.

6. The electrochemical cell according to claim 1, wherein the cathode active material is selected from.-lithium intercalating mixed oxides of Ni, Co, Al and Mn.

7. The electrochemical cell according to claim 1, wherein the electrolyte composition (C) contains at least one cyclic carbonate containing at least one double bond selected from vinylene carbonate, methyl vinylene carbonate, 4,5-dimethyl vinylene carbonate, methylene ethylene carbonate, and 4,5-dimethylene ethylene carbonate.

8. The electrochemical cell according to claim 1, wherein the weight ratio of compounds (iii) to compounds (iv) in the electrolyte composition (C) is in the range of 1:20 to 20:1.

9. The electrochemical cell according to claim 1, wherein the total concentration of compounds (iii) and compounds (iv) in the electrolyte composition (C) is in the range of 0.01 to 10 wt.-%, based on the total weight of electrolyte composition (C).

10. The electrochemical cell according to claim 1, wherein the electrolyte composition (C) contains vinylene carbonate and LiPO₂F₂.

11. The electrochemical cell according to claim 1, wherein the electrolyte composition (C) contains less than 1 wt.-% halogenated organic carbonate, based on the total weight of the electrolyte composition (C).

12. The electrochemical cell according to claim 1, wherein the aprotic organic solvent (i) is selected from cyclic and acyclic organic carbonates, di-C₁-C₁₀-alkylethers, di-C₁-C₄-alkyl-C₂-C₆-alkylene ethers and polyethers, cyclic ethers, cyclic and acyclic acetales and ketales, orthocarboxylic acids esters, cyclic and acyclic esters and diesters of carboxylic acids, cyclic and acyclic sulfones, and cyclic and acyclic nitriles and dinitriles and mixtures thereof.

13. The electrochemical cell according to claim 1, wherein the aprotic organic solvent (i) is selected from cyclic and acyclic organic carbonates.

14. The electrochemical cell according to claim 1, wherein the lithium conducting salt (ii) is selected from LiPF₆, LiAsF₆, LiSbF₆, LiCF₃SO₃, LiBF₄, lithium bis(oxalato) borate, LiClO₄, LiN(SO₂C₂F₅)₂, LiN(SO₂CF₃)₂, LiN(SO₂F)₂, and LiPF₃(CF₂CF₃)₃.

15. The electrochemical cell according to claim 1, wherein the electrolyte composition (C) contains at least one further additive (v) selected from polymers, film forming additives, flame retardants, overcharging additives, wetting agents, HF and/or H₂O scavenger, stabilizer for LiPF₆ salt, ionic solvation enhancer, corrosion inhibitors, and gelling agents.
